(19) United States
(12) Patent Application Publication
(10) Pub. No.: US 2017/0132366 A1
(43) Pub. Date: May 11, 2017

(54) Platform for Administration of Personal Health Information

(71) Applicant: DELL SOFTWARE, INC., Round Rock, TX (US)

(72) Inventor: Seth M. Feder, Austin, TX (US)

(73) Assignee: DELL SOFTWARE, INC., Round Rock, TX (US)

(21) Appl. No.: 14/934,720

(22) Filed: Nov. 6, 2015

(51) Int. Cl. G06F 19/00; G06Q 30/02

(52) U.S. Cl. CPC G06F 19/322; G06Q 30/0208

(57) ABSTRACT

A system, method, and computer-readable medium are disclosed for performing personal healthcare administration, comprising: receiving health information from a consumer to a business intelligence suite via a portal; receiving a query regarding a healthcare study from a buyer, the healthcare study including a request for health information from the consumer; and, providing the consumer with an incentive for the consumer providing the health information to the business intelligence suite.

### BACKGROUND OF THE INVENTION

Field of the Invention

The present invention relates to information handling systems. More specifically, embodiments of the invention relate to a platform for administration and dissemination of personal health information.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Individuals generally do not track their personal health information until they experience a problem. One reason is lack of incentives, having good health is a good reward in itself but often is taken for granted. Employers who often contribute to the cost of healthcare (e.g., by providing and/or subsidizing health insurance) frequently encourage personal health improvement because the employer can benefit from lower healthcare costs with employees' improved health.

### SUMMARY OF THE INVENTION

A system, method, and computer-readable medium are disclosed for performing personal healthcare administration, comprising: receiving health information from a consumer to a business intelligence suite via a portal; receiving a query regarding a healthcare study from a buyer, the healthcare study including a request for health information from the consumer; and, providing the consumer with an incentive for the consumer providing the health information to the business intelligence suite.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a personal healthcare administration platform.

### DETAILED DESCRIPTION

A system, method, and computer-readable medium are disclosed for performing a personal healthcare administration operation. The personal healthcare administration operation provides personal health tracking, improvement, and even disease management such that an individual may receive incentives for using performing the healthcare administration operation. In various embodiments, the incentives include one or more of inducements, invitations, consideration, discounts, compensation and remuneration. In certain embodiments, the healthcare administration operation is provided via a health and wellness platform. Additionally, in certain embodiments, the health and wellness platform is cloud-based. In various embodiments, the health and wellness platform enables monetizing health for the individual who actually experiences and benefits from being healthy.

In certain embodiments, the platform includes a web based portal with roles for Consumers and for Buyers. Consumers are any person interested in tracking and improving their health and possibly earning money for doing so. Buyers are any entity interested in collecting and mining the aggregated data from consumers, and thus willing to pay consumers for such access. Consumers begin by creating a profile and completing a detailed medical history which is then stored within a database. An identity management module verifies the consumer identity against a known and trusted database, such as a credit reporting bureau to validate the account is associated with an actual person. Once validated, the consumer begins tracking their health either by importing electronically their health information from a variety of sources, or by manually entering historic information. A data import utility allows the consumers to build a history from electronic medical records (e.g., via a health level 7 (HL7) interface, for example, if supported by the sending organization), personal health device websites (such as the website), and from exercise and fitness websites such as the Strava and/or Garmin websites). Additionally, an interface to other health websites is established by for example using published application programming interfaces (API's), The other health websites may also be accessed via a cloud integration services such as the Dell Inc. Boomi cloud integration service if needed. If the consumer wishes, they may track food consumption as well with a food log. Additionally, if the consumer wishes they can also provide information from personal health devices such as scales, blood pressure monitors, and blood sugar monitors, etc. As consumers input their data into the system, the data is anonymized, indexed, and prepared for ad hoc queries for those entities granted rights to such access by the consumer.

For the buyer role, their entry into the portal allows a buyer to build their own profile as a business and potential purchaser of the data collected in this platform. Buyers are provided access to a query interface, and can structure requests in plain language. The platform transforms the plain language requests into analytical code tier retrospective studies. For example, the buyer may ask “how many males between the ages of 20-40 are taking Plavix brand medicine and have shown a reduction in blood pressure without a routine exercise regimen?,” which the platform returns with a cost of such a query along with descriptive statistics behind the numbers available. in this example it might reply “The database contains 1,567 individuals that match your criteria and can provide an answer with 0.05% confidence interval of the population, for a cost of $35,000.” The buyer then decides to purchase the results, and the proceeds are shared with the individuals who provided the data and the owner of the platform. Further, if the data does not exist, the buyer may create a data collection event and offer a reward for individuals to contribute data over a set amount of time (i.e. a prospective study). These events are presented to the consumer in a marketplace, where consumers can browse and select events to join and be compensated.

Buyers may be pharmaceutical companies, population health researchers, behavioral scientists, economists, or insurance payers for example. This approach advantageously connects consumers and buyers with an analytical engine, and creates an economy of incentives. The approach is device independent, and does not leverage any one platform in the hands of either the consumer or the buyer.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

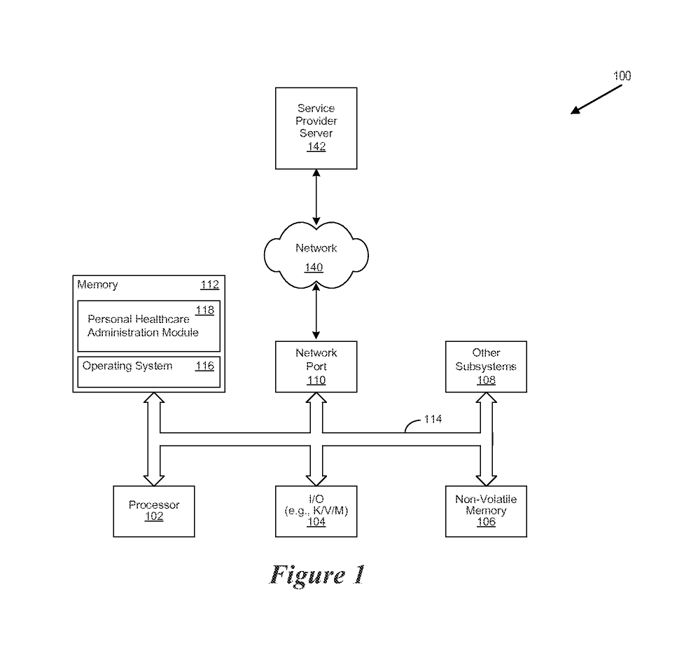

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise healthcare administration module 118.

The healthcare administration module 118 performs a personal healthcare administration operation. The personal healthcare administration operation provides personal health tracking, improvement, and even disease management such that an individual may receive incentives for using performing the healthcare administration operation. In certain embodiments, the healthcare administration operation is provided via a health and wellness platform. Additionally, in certain embodiments, the health and wellness platform is cloud-based. In various embodiments, the health and wellness platform enables monetizing health for the individual who actually experiences and benefits from being healthy.

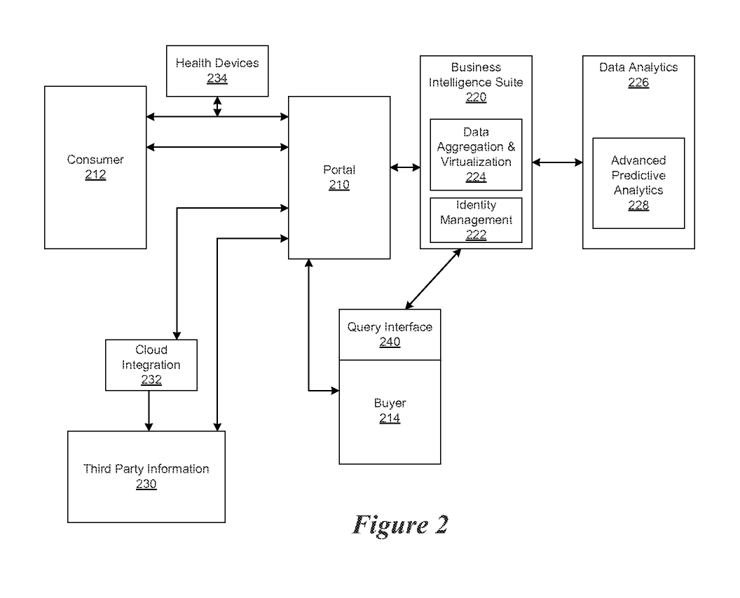

Referring to FIG. 2, a block diagram of a personal healthcare administration platform 200 is shown. In certain embodiments, the personal healthcare administration platform 200 includes a web based portal 210 with rotes for consumers 212 and for buyers 214. The platform 200 further includes a business intelligence suite 220 which includes an identify management system 222 and a data aggregation and virtualization system 224. The platform 200 further includes a data analytics system 226 which includes an advanced predictive analytics system 228. In various embodiments, the data analytics system 226 includes the Dell Statistica data analytics system. The Dell Statistica data analytics system provides advanced statistical functions such as data classification, data visualization, clustering, natural language processing, and analysis of variance. In various embodiments, the platform 200 includes one or move third party information sources 230 which interact with the business intelligence suite 220 via a cloud integration portal 232. In various embodiments, the third party information sources include one or more third party health websites. In various embodiments, the platform includes one or more personal health devices 234 which interact with either or both the consumer 212 and the portal 210.

Consumers 212 are any person interested in tracking and improving their health and possibly earning money for doing so. Buyers 214 are any entity interested in collecting and mining the data from consumers, and thus willing to pay consumers for such access. Consumers 212 begin by creating a profile and completing a detailed medical history which is then stored within a database. The portal 210 interacts with a business intelligence suite 220 which includes an identity management module 222 which verifies the consumer identity against a known and trusted database, such as a credit reporting bureau to validate the account is associated with an actual person. Once validated, the consumer begins tracking their health by importing electronically their health information from a variety of sources.

A data import utility allows the consumers 212 to build a history from electronic medical records (e.g., via a health level 7 (HL7) interface, for example, if supported by the sending organization), personal health device websites (such as the Fitbit website), and from exercise and fitness websites (such as the Strava and/or Gamin websites). Optionally, the user may manually input data into fields that they define, or are made available to them in standardized templates. Additionally, an interface to other third party information 230 such as third party health websites is established by for example using published application programming interfaces (API's). The other health websites may also be accessed via a cloud integration services 232 such as the Dell Inc. Boomi cloud integration service if needed. If the consumer wishes, they may track food consumption as well with a food log. Additionally, if the consumer 212 wishes they can also provide information from personal health devices 234 such as scales, blood pressure monitors, and blood sugar monitors. As consumers 212 input their data into the system 200, the data anonymized, indexed, and prepared for ad hoc queries. However, in certain embodiments no queries can be made against the data unless and until the user grants permission for its use. Without permission, the data remains completely private and unviewable by any entity other than the user.

For the buyer 214, entry into the portal allows a buyer 214 to build their own profile as a business and potential purchaser of the data collected in this platform. Buyers 214 are provided access to a query interface 240 (e.g., a query dashboard), and can structure requests in plain language. The platform 200 transforms the plain language requests into analytical code for retrospective studies. For example, the buyer 214 may ask “how many males between the ages of 20-40 are taking Plavix brand medicine and have shown a reduction in blood pressure without a routine exercise regimen?,” which the platform returns with a cost of such a query along with descriptive statistics behind the numbers available. In this example it might reply “The database contains 1,567 individuals that match your criteria and can provide an answer with 0.05% confidence interval of the population, for a cost of $35,000.” The buyer 214 then decides to purchase the results, and the proceeds are shared with the individuals who provided the data and the owner of the platform. Further, if the data does not exist, the buyer 214 may create a data collection event and offer a reward for individuals to contribute data over a set amount of time (i.e. a prospective study). These events are presented to the consumer 212 in a marketplace which is accessed via the portal 210, where consumers can browse and select events to join and be compensated.

Buyers 214 may be pharmaceutical companies, population health researchers, behavioral scientists, economists, or insurance payers for example. This approach advantageously connects consumers and buyers with an analytical engine, and creates an economy of incentives. The approach is device independent, and does not leverage any one platform in the hands of either the consumer or the buyer.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may he provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing personal healthcare administration, comprising:
receiving health information from a consumer to a business intelligence suite via a portal;
receiving a query regarding a healthcare study from a buyer, the healthcare study including a request for health information from the consumer; and,
providing the consumer with an incentive for the consumer providing the health information to the business intelligence suite.

2. The method of claim 1, wherein:
the personal healthcare administration enables personal health tracking, improvement, and even disease management

3. The method of claim 1, wherein:
the incentive includes one or more of inducements, invitations, consideration, discounts, compensation and remuneration.

4. The method of claim 1, wherein:
the health information and the query are received via a portal, the portal providing the health information and the query to the business intelligence suite.

5. The method of claim 1, further comprising:
performing an identity management operation on the health information provided by the consumer, the health management operation verifying an identity of the consumer.

6. The method of claim 1, wherein:
health information is provided by at least one of a health website containing health information of the consumer and a personal health device associated with the consumer.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving health information from a consumer to a business intelligence suite via a portal;
receiving a query regarding a healthcare study from a buyer, the healthcare study including a request for health information from the consumer; and,
providing the consumer with an incentive for the consumer providing the health information to the business intelligence suite.

8. The system of claim 7, wherein:
the personal healthcare administration enables personal health tracking, improvement, and even disease management

9. The system of claim 7, wherein:
the incentive includes one or more of inducements, invitations, consideration, discounts, compensation and remuneration.

10. The system of claim 7, wherein:
the health information and the query are received via a portal, the portal providing the health information and the query to the business intelligence suite.

11. The system of claim 7, wherein the instructions are further configured for:
performing an identity management operation on the health information provided by the consumer, the health management operation verifying an identity of the consumer.

12. The system of claim 7, wherein:
health information is provided by at least one of a health website containing health information of the consumer and a personal health device associated with the consumer.

13. A non-transitory, computer-readable storage medium embodying computer program code, the computer program code comprising computer executable instructions configured for:
receiving health information from a consumer to a business intelligence suite via a portal;
receiving a query regarding a healthcare study from a buyer, the healthcare study including a request for health information from the consumer; and,
providing the consumer with an incentive for the consumer providing the health information to the business intelligence suite.

14. The non-transitory, computer-readable storage medium of claim 13, wherein:
the personal healthcare administration enables personal health tracking, improvement, and even disease management

15. The non-transitory, computer-readable storage medium of claim 13, wherein:
the incentive includes one or more of inducements, invitations, consideration, discounts, compensation and remuneration.

16. The non-transitory, computer-readable storage medium of claim 13, wherein:
the health information and the query are received via a portal, the portal providing the health information and the query to the business intelligence suite.

17. The non-transitory, computer-readable storage medium of claim 13, wherein the computer executable instructions are further configured for:
performing an identity management operation on the health information provided by the consumer, the health management operation verifying an identity of the consumer.

18. The non-transitory, computer-readable storage medium of claim 13, wherein:
health information is provided by at least one of a health website containing health information of the consumer and a personal health device associated with the consumer.
